(19) United States
(12) Patent Application Publication
(10) Pub. No.: US 2024/0242297 A1
(43) Pub. Date: Jul. 18, 2024

(54) RECIPE SUGGESTING APPARATUS, RECIPE SUGGESTING METHOD, AND PROGRAM

(71) Applicant: NIPPON TELEGRAPH AND TELEPHONE CORPORATION, Tokyo (JP)

(72) Inventors: Akira TAKEUCHI, Tokyo (JP); Takashi FURUTANI, Tokyo (JP); Yuriko TANAKA, Tokyo (JP)

(73) Assignee: NIPPON TELEGRAPH AND TELEPHONE CORPORATION, Tokyo (JP)

(21) Appl. No.: 18/562,297

(22) PCT Filed: May 28, 2021
(86) PCT No.: PCT/JP2021/020540

§ 371 Date: Nov. 18, 2023

(51) Int. Cl. G06Q 50/10

(52) U.S. Cl. CPC G06Q 50/10

(57) ABSTRACT

The purpose of this invention is to provide consumers with information capable of inducing food demand to consume surplus ingredients by obtaining consumer data and a simple calculation method.

A recipe proposal device which proposes a recipe to a consumer inputs ingredient information indicating available ingredients and selects a specific recipe to be proposed to a predetermined consumer from predetermined recipes that the predetermined consumer has browsed in the past on the basis of the recipe in which the ingredients shown in the ingredient information is used.

### TECHNICAL FIELD

The present disclosure relates to a recipe proposal device, a recipe proposal method, and a program.

### BACKGROUND ART

Food waste in Japan is estimated by the Ministry of Agriculture, Forestry and Fisheries to be more than 6 million tons per year, and the causes are hidden in various stages between factories, distribution, retail, restaurants and households. In order to reduce food loss from households, there is a system which supports cooking in consideration of the inventory of ingredients possessed by households (for example, PTL 1). On the other hand, there is also a food sharing service in which meals that are unlikely to be sold in stores at a good price can be purchased and proof-of-concept experiments are also being conducted at stores, such as selling leftover agricultural products at direct sales stores at stations, and the like, and sharing them with employees of commercial facilities (URL: https://tabete.me/).

### CITATION LIST

### Patent Literature

[PTL 1] Japanese Patent Application Publication No. 2005-32188

### SUMMARY OF INVENTION

### Technical Problem

However, while consumer preferences for food are diverse, a large amount of information is required to analyze the preferences of each consumer. Thus, there are problems in data acquisition and calculation methods. Therefore, there is a concern that conventional systems do not take into consideration the tastes of consumers or fail to analyze tastes accurately so that the consumption of surplus ingredients is not promoted.

The present invention was made in view of the above-described problems, and an object of the present invention is to provide consumers with information which can induce a food demand to consume surplus ingredients.

### Solution to Problem

In order to solve the above problems, the invention according to claim 1 is a recipe proposal device which proposes a recipe to a consumer which includes: an input means for inputting ingredients information indicating available ingredients; and a selection means for selecting a specific recipe to be proposed to a predetermined consumer from predetermined recipes browsed by the predetermined consumer in the past on the basis of the recipe in which the ingredients indicated by the ingredients information input by the input means is used.

### Advantageous Effects of Invention

As described above, according to the present invention, consumers can be provided with information capable of inducing food demand to consume surplus ingredients.

### BRIEF DESCRIPTION OF DRAWINGS

FIG. 1 is a schematic diagram of a communication system.

FIG. 2 is an electrical hardware configuration diagram of a recipe proposal device.

FIG. 3 is an electrical hardware configuration diagram of a communication terminal.

FIG. 4 is a functional configuration diagram of a recipe proposal device.

FIG. 5 is an image diagram showing a configuration example of a recipe database.

FIG. 6 is an image diagram showing a configuration example of a history database.

FIG. 7 is a flowchart for describing an example of a procedure for registration in a recipe database on the basis of text data of a recipe.

FIG. 8 is a flowchart for describing an example of a procedure for transmitting recipe information to a consumer's communication terminal in response to an input of ingredient information and receiving consumer's browsing information from the communication terminal.

### DESCRIPTION OF EMBODIMENTS

An embodiment of the present invention will be described below on the basis of the drawings. In the embodiment, among various recipes, particularly food recipes as documents describing cooking methods will be described.

### [System Configuration of Embodiment]

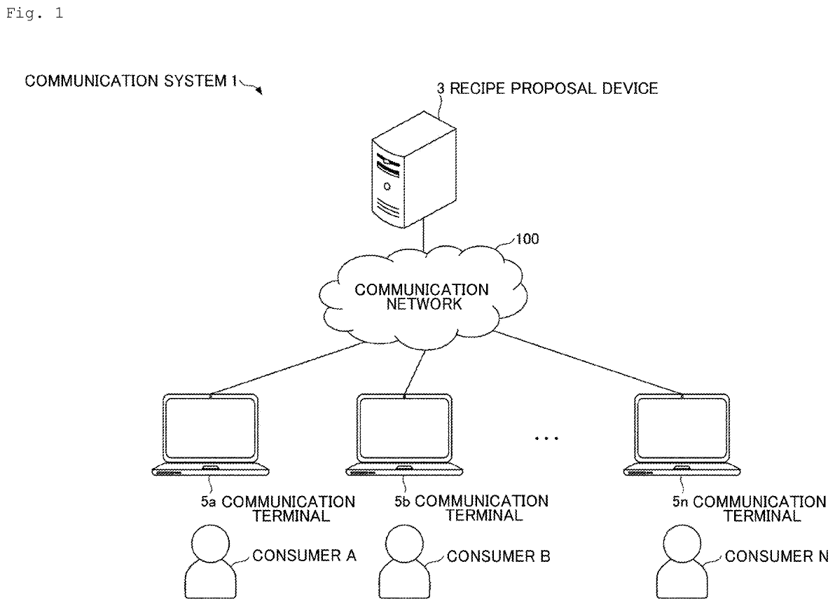

First, an outline of a configuration of a communication system according to an embodiment will be described with reference to FIG. 1. FIG. 1 is a schematic diagram of a communication system according to an embodiment of the present invention.

As shown in FIG. 1, a communication system 1 of the embodiment is constructed by a recipe proposal device 3 and a plurality of communication terminals 5a, 5b, . . . , and 5n. Each of the communication terminals 5a, 5b, . . . , and 5n is managed and used by consumers A, B, . . . , and N, respectively. Note that hereinafter an arbitrary communication terminal among the communication terminals 5a, 5b, . . . , and 5n is indicated as a “communication terminal 5”. n and N are integers.

Furthermore, the communication terminal 5 and the recipe proposal device 3 can communicate via a communication network 100 such as the Internet. A connection form of the communication network 100 may be either wireless or wired.

The recipe proposal device 3 is composed of one or more computers. When the recipe proposal device 3 is composed of a plurality of computers, the recipe proposal device 3 is also a recipe proposal system.

The recipe proposal device 3 transmits recipe information indicating the optimum recipe to be proposed to each consumer's communication terminal to propose the optimum recipe to each consumer among a plurality of recipes using ingredients which each consumer can use.

The communication terminal 5 is a computer and FIG. 1 shows a notebook computer as an example.

### [Hardware Configuration]

### <Hardware Configuration of Recipe Proposal Device>

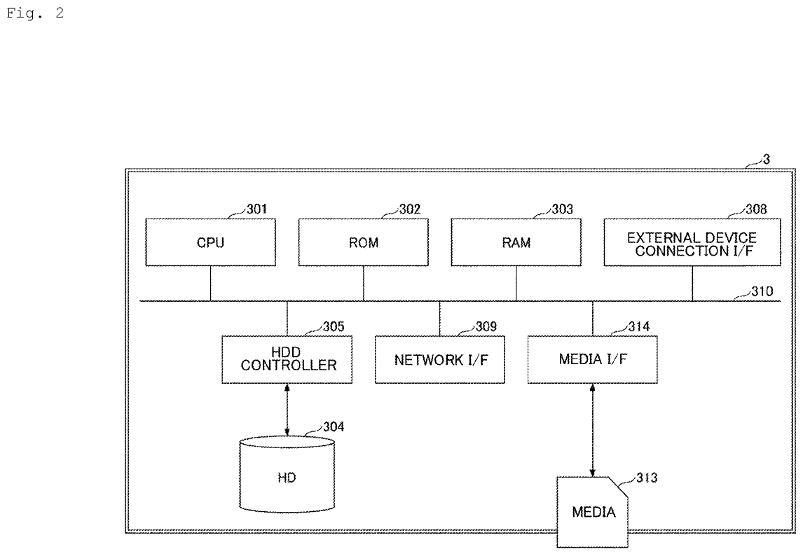

The electrical hardware configuration of the recipe proposal device 3 will be described below with reference to FIG. 2. FIG. 2 is an electrical hardware configuration diagram of the recipe proposal device.

As shown in FIG. 2, the recipe proposal device 3 includes, as a computer, a central processing unit (CPU) 301, a read only memory (ROM) 302, a random access memory (RAM) 303, a hard disk (HD) 304, a hard disk drive (HDD) controller 305, an external device connection interface (I/F) 308, a network I/F 309, a bus line 310, and a media I/F 314.

Among these, the CPU 301 controls an operation of the recipe proposal device 3 as a whole. The ROM 302 stores programs used for driving the CPU 301, such as an initial program loader (IPL). The RAM 303 is used as a work area for the CPU 301.

The HD 304 stores various data such as programs. The HDD controller 305 controls reading or writing of various data to/from the HD 304 under the control of the CPU 301. Note that, instead of the HD 304 and HDD controller 305, a solid state drive (SSD), and an SSD controller may be installed.

The external device connection I/F 308 is an interface for connecting various external devices. The external devices in this case are displays, speakers, keyboards, mice, universal serial bus (USB) memories, printers, and the like.

A network I/F 309 is an interface for data communication via the communication network 100. A bus line 310 is an address bus, a data bus, or the like for electrically connecting each component such as the CPU 301 shown in FIG. 2.

Furthermore, a media I/F 314 controls reading or writing (storage) of data to a recording medium 313 such as a flash memory. The recording medium 313 also includes a digital versatile disc (DVD), a Blu-ray Disc (registered trademark), and the like.

### <Hardware Configuration of Communication Terminal>

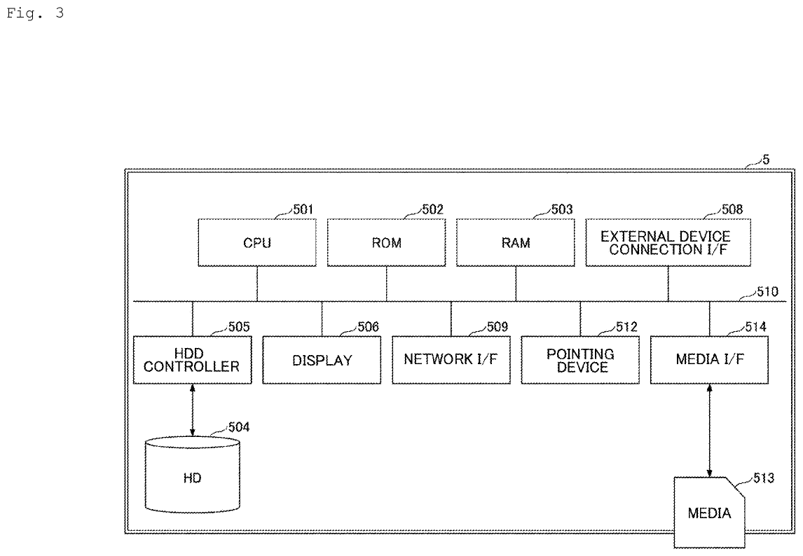

An electrical hardware configuration of the communication terminal 5 will be described below with reference to FIG. 3. FIG. 3 is an electrical hardware configuration diagram of a communication terminal.

As shown in FIG. 3, the communication terminal 5 includes, as a computer, a CPU 501, a ROM 502, a RAM 503, an HD 504, an HDD controller 505, a display 506, an external device connection I/F 508, a network I/F 509, a bus line 510, a pointing device 512, and a media I/F 514.

Among these, the CPU 501 controls an operation of the communication terminal 5 as a whole. The ROM 502 stores a program used for driving the CPU 501, such as IPL. The RAM 503 is used as a work area for the CPU 501.

The HD 504 stores various data such as programs. The HDD controller 505 controls reading or writing of various data to/from the HD 504 under the control of the CPU 501. Note that, instead of the HD 504 and the HDD controller 505, the solid state drive (SSD) and the SSD controller may be installed.

The display 506 is a kind of display means such as liquid crystal or organic electro luminescence (EL) which displays various images. The external device connection I/F 508 is an interface for connecting various external devices. The external devices in this case are displays, speakers, keyboards, mice, USB memories, printers, and the like.

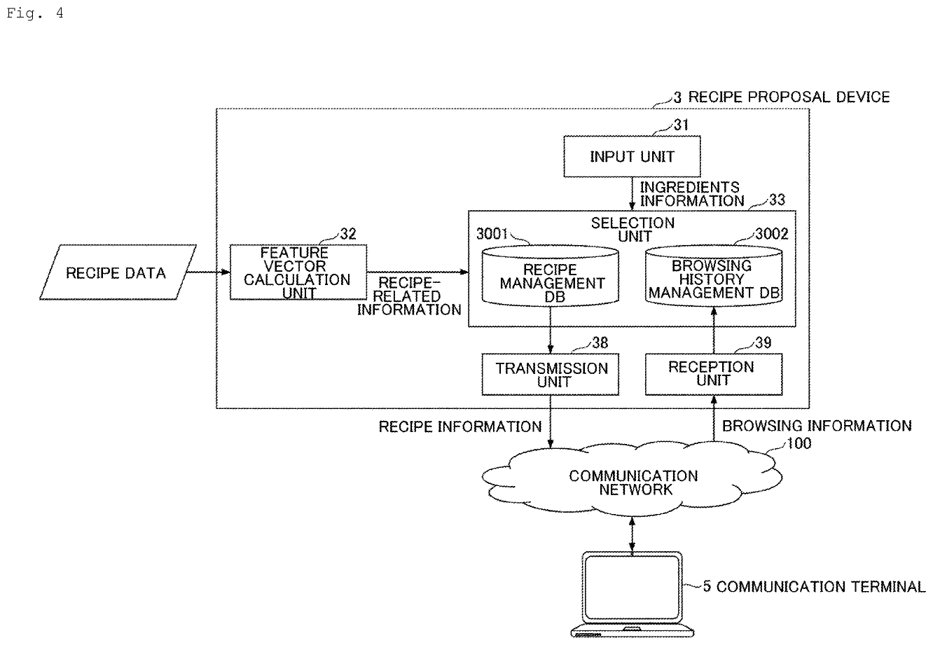

The network I/F 509 is an interface for data communication via the communication network 100. The bus line 510 is an address bus, a data bus, or the like for electrically connecting each component such as the CPU 501 shown in FIG. 4.

Furthermore, the pointing device 512 is a type of input means for selecting and executing various instructions, selecting processing targets, moving a cursor, and the like. Note that, when the user (customer) uses the keyboard, the function of the pointing device 512 may be turned off. The media I/F 514 controls reading or writing (storage) of data to a recording medium 513 such as a flash memory. The recording media 513 also include DVDs, Blu-ray Discs (registered trademark), and the like.

### [Functional Configuration of Recipe Proposal Device]

A functional configuration of the recipe proposal device will be described below with reference to FIG. 4. FIG. 4 is a functional configuration diagram of the recipe proposal device in the embodiment of the present invention.

In FIG. 4, the recipe proposal device 3 has an input unit 31, a feature vector calculation unit 32, a selection unit 33, a transmission unit 38, and a reception unit 39. These units are functions realized by instructions from the CPU 301 in FIG. 2 on the basis of programs. In addition, a recipe management DB 3001 and a browsing history management DB 3002 are constructed in the RAM 303 or HD 304 of FIG. 2.

### <Table Configuration>

### (Recipe Management Table)

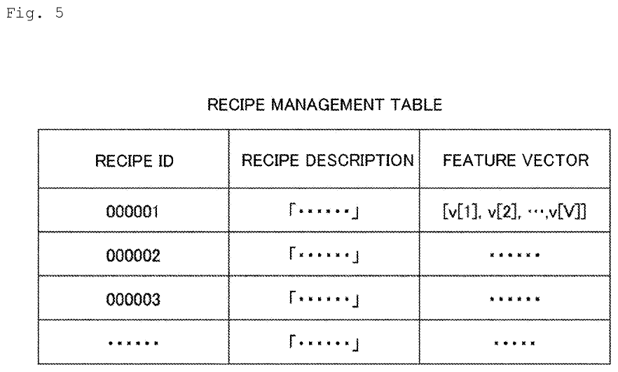

A recipe management table will be described with reference to FIG. 5. FIG. 5 is an image diagram showing a configuration example of a recipe database. The recipe management DB 3001 in FIG. 4 is composed of a recipe management table as shown in FIG. 5. Recipe-related information is managed in the recipe management table. The recipe-related information is information in which a recipe ID, a recipe description, and a feature vector are associated. Note that a feature vector is an example of a “feature amount”. A “feature amount” includes parameters in which vectors are not used. Note that the feature vector managed by the recipe management table is the first feature vector and the feature amount in this case is the first feature amount.

A recipe ID is an example of recipe identification information for identifying each recipe. A recipe description is a document which describes a cooking method and the like and is, for example, represented by text data. Feature vectors will be described later.

### (History Management Table)

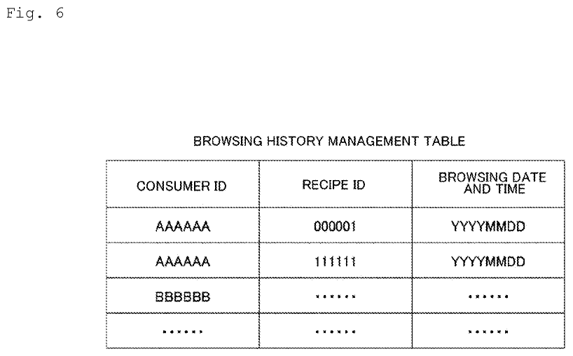

A browsing history management table will be described with reference to FIG. 6. FIG. 6 is an image diagram showing a configuration example of a history database. The browsing history management DB 3002 in FIG. 4 is composed of a browsing history management table as shown in FIG. 6. In the browsing history management table, browsing information indicating the status of browsing of the recipe content based on the recipe information on the communication terminal 5 is managed. The browsing information is information in which the consumer ID, the recipe ID, and the browsing date and time are associated.

The consumer ID is an example of consumer identification information for identifying each consumer. The recipe IDs in FIG. 6 are the same as the recipe IDs in the recipe management table in FIG. 5. The browsing date and time is browsing date and time information indicating the date and time when the consumer has browsed the recipe content relating to the recipe information transmitted by the recipe proposal device 3.

### <Each Function Configuration>

Returning to FIG. 4, the input unit 31 externally inputs ingredients information indicating available ingredients via the external device connection I/F 308 or the media I/F 314 in FIG. 2. The ingredient information indicates, for example, ingredients which are expected to be surplus.

The feature vector calculation unit 32 calculates a (first) feature vector of character information indicating each recipe from the description of the recipe as recipe data. In this case, the feature vector calculation unit 32 generates a unique recipe ID to identify the description of each recipe. Furthermore, the feature vector calculation unit 32 registers (stores) recipe-related information (recipe ID, recipe description, feature vector) in the recipe management DB 3001.

The selection unit 33 refers to the recipe management DB 3001 and the browsing history management DB 3002 and selects the optimum recipe to be proposed to each consumer.

The transmission unit 38 transmits the recipe information to each consumer's communication terminal 5 via e-mail, SNS, or the like from the network I/F 309 via the communication network 100 in FIG. 2 on the basis of the output of the selection unit 33.

The reception unit 39 receives browsing information (consumer ID, recipe ID, browsing date and time) through the network I/F 309 in FIG. 2 from the communication terminal 5 of each consumer via the communication network 100 and registers it in the browsing history management DB 3002.

Note that, although the browsing date and time indicates the date and time when the recipe information was browsed on the communication terminal 5, the date and time when the recipe proposal device 3 received the consumer ID and the recipe ID from the communication terminal 5 may be indicated. In this case, the browsing information transmitted from the communication terminal 5 to the recipe proposal device 3 does not include browsing date and time information.

### [Processing or Operation]

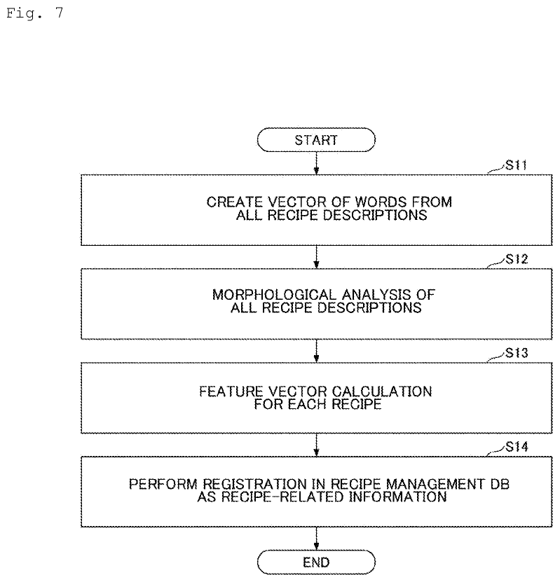

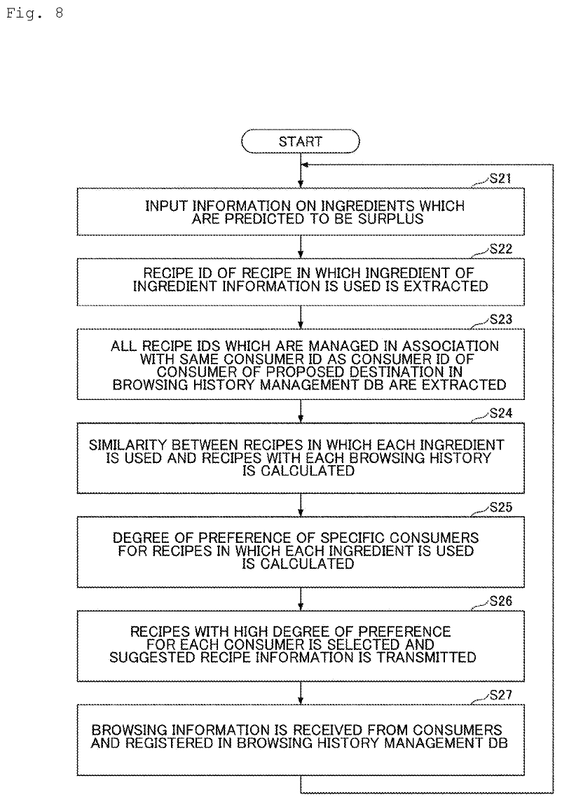

Processing or operation of the embodiment will be described below with reference to FIGS. 7 and 8.

### <Registration Processing to Recipe Management DB>

First, the process of registering in the recipe management DB 3001 will be described with reference to FIG. 7. FIG. 7 is a flowchart for describing an example of a procedure for registration in the recipe management DB 3001 on the basis of the description of the recipe.

First, as a preliminary preparation, the feature vector calculation unit 32 creates word vectors (about several hundred dimensions) by an existing technique such as word2vec (S11). This is a machine learning method in which a large amount of pieces of text data to predict words which appear around a certain word are used on the basis of the distribution hypothesis in which words appearing in the same context have similar meanings. If the recipe description is used as text data, it is possible to more accurately acquire the characteristics of words used in recipes by analyzing synonyms and synonyms specific to ingredients and dishes, as well as ingredients and seasonings that can be used as substitutes.

Subsequently, the feature vector calculation unit 32 divides the description of each recipe into words by performing morphological analysis using an existing tool (such as Mecab) (S12). The feature vector calculation unit 32 vectorizes each word obtained from the description of the recipe using a vector of words prepared in advance, evaluates the importance of words by existing methods such as tf-idf and attention mechanism, and calculates a feature vector of information indicating each recipe (S13). It is also possible to reflect tastes such as “light” and “rich” flavors, and cooking time and effort such as “easy” in recipe feature vectors using not only nouns such as ingredients and seasonings, but also adjectives and adjectives. Furthermore, the feature vectors may be normalized (the magnitude of the vectors is set to 1), thereby reducing the similarity calculations which will be described below. The feature vector calculation unit 32 associates the feature vector calculated as described above with each recipe ID, and registers it in the recipe management DB 3001 as recipe-related information (S14).

Note that the processing of steps S11 to S13 may not be performed by the recipe proposal device 3, but may be executed by another PC or the like.

### <Recipe Suggestion Processing>

Recipe proposal processing will be described below with reference to FIG. 8. FIG. 8 is a flowchart for describing an example of a procedure for transmitting recipe information to a consumer's communication terminal in response to input of ingredients information and receiving consumer's browsing information from the communication terminal.

First, the input unit 31 inputs ingredient information indicating ingredients that are expected to have a surplus (S21). For example, ingredients information is input or information is transmitted from a communication terminal in a food production factory or store. Furthermore, for example, targeting consumers who live in the vicinity of the place where ingredients information is input and the selection unit 33 extracts recipe IDs of recipes using each ingredient indicated by the ingredients information input by the input unit 31 from the recipe management DB 3001 (S22). For this extraction, the selection unit 33 refers to each ingredient name and the like described in the description of the recipe in the recipe management DB 3001. Thus, for example, the recipe ID “00001” is extracted.

Subsequently, the selection unit 33 extracts all recipe IDs managed in association with the same consumer ID as the consumer ID of the proposed consumer in the browsing history management DB 3002 (S23). Thus, for example, recipe IDs “000001” and “111111” corresponding to consumer ID “AAAAAA” are extracted.

Also, the selection unit 33 calculates similarity between the specific recipe indicated by the recipe ID extracted in step S22 and each recipe indicated by each recipe ID extracted in step S23 using, for (Expression 1), the feature vector (second feature vector) associated with the recipe ID extracted in step S22 and each feature vector (first feature vector) associated with all of the recipe IDs extracted in step S23 (S24). Note that a second feature vector is an example of a second feature amount.

Also, in this case, each feature vector of all recipe IDs extracted in step S23 is extracted from recipe management DB 3001 based on the recipe ID. If the feature vector (number of dimensions V) is normalized, the recipe similarity Sn based on the feature vector vᵣ of the recipe r obtained in step S22 and the feature vector vₕ of the recipe h obtained in step S23 is expressed by (Equation 1).

$$[ Math . 1 ]$$

$${S}_{rh} = {R}_{s} {R}_{w} {\sum }_{i = 1}^{V} ( {v}_{r} [ i ] {v}_{h} [ i ] ) \qquad ( Formula 1 )$$

Here, Rₛ is similarity between the historical data season and the current season and is 1 for the same month and day (MMDD), and a small value close to 0 for opposite seasons such as February and August needs to be set in a table or the like. Thus, the recipe proposal device 3 can avoid suggesting recipes in winter which are highly similar to recipes in which a certain consumer prefers in summer. In addition, R_{w} is similarity between the day of the week in the historical data and the current day of the week and the recipe proposal device 3 makes it difficult to propose recipes on weekdays which are highly similar to recipes in which a user wants to cook on holidays. This is to reflect, for example, cooking which requires time and effort on holidays, but easy cooking on weekdays, and can be set for each consumer based on the similarity between the history of weekdays and the history of holidays.

Subsequently, the selection unit 33 uses (Formula 2) to calculate the degree of preference of each consumer for a recipe in which the ingredient indicated by the input ingredient information is used (S25). The degree of preference Sᵣ of the consumer for the recipe r using the ingredient indicated by the ingredient information input by the input unit 31 is the maximum value of the similarity with each recipe having a browsing history (here, the number of recipes H) (Formula 2).

$$[ Math . 2 ]$$

$${S}_{r} = max \{ {S}_{r 1} , {S}_{r 2} , … {S}_{rH} \} \qquad ( Formula 2 )$$

Subsequently, the selection unit 33 selects an arbitrary number (for example, three) of recipes with a high degree of preference in (Formula 2) for each consumer and the transmission unit 38 transmits the recipe information (the URL of the web page in which the summary information of the recipe and the detailed information of the recipe are described) to each consumer via e-mail, SNS, or the like (S26). Detailed recipe information is, for example, information including text and images posted by people who provided or created the recipe, or sent from those people, and may include moving images.

Also, if a predetermined consumer of the communication terminal 5 who received the recipe information browses the recipe of interest, the reception unit 39 receives browsing information (consumer ID, recipe ID, browsing date and time) from the communication terminal 5 and registers browsing information in the browsing history management DB 3002 as information specifying a prescribed recipe browsed by a prescribed consumer in the past (S27). Note that, since it is better to register only recipes that consumers like with as little effort as possible, it may be assumed that the consumer likes the web page describing the detailed information of the recipe when the web page is browsed a predetermined number of times (for example, twice) or more in one day. Note that, for consumers who do not have a browsing history, a questionnaire may be taken in advance, or data of consumers who have similar attributes (residence, gender, preferences, and the like) may be used. Furthermore, in order to reduce the calculation cost of recipe selection and to transmit recipe information to the consumer's communication terminal for various recipes, recipes in which the input ingredients are used may be randomly sampled instead of all.

### Effect of Embodiment

As described above, according to the embodiment, the recipe proposal device 3 has, as targets, consumers living in the surrounding area for ingredients which are expected to be surplus and transmits recipe information which matches the preferences of each consumer and the season and day of the week obtained by simple data collection and calculation. Thus, waste is prevented by inducing food demand to use ingredients which are expected to be surplus, which has the effect of reducing food loss.

### Supplementary Notes

The present invention is not limited to the above-described embodiments and may be configured or processed (operations) as described below.
(1) When the same recipe ID “000001” is extracted by chance in Steps S23 and 24, the calculation of the similarity of feature vectors in Step S23 may be omitted.
(2) In communication between the recipe proposal device 3 and the communication terminal 5, another device (server, router, or the like) may relay data. For example, although it is described that the transmission unit 38 of the recipe proposal device 3 transmits the recipe information to the communication terminal 5 for the sake of simplification in this specification, this transmission processing is meant to also include the case in which the recipe information is relayed by another device. Similarly, although it is described that the reception unit 39 of the recipe proposal device 3 receives the browsing information from the communication terminal 5 for the sake of simplification in this specification, this receiving process is meant to include cases in which another device relays the browsing information.
(3) Although a notebook computer is shown as an example of the communication terminal 5 in the above embodiment, the present invention is not limited to this and may be, for example, a desktop computer, tablet terminal, smart phone, smart watch, car navigation device, refrigerator, microwave oven, or the like.
(4) Each of the above programs may be distributed by being recorded on a recording medium such as a DVD.
(5) each of the CPUs 301 and 501 may be not only a single one but may be a plurality of CPUs.

### REFERENCE SIGNS LIST

1 Communication system
3 Recipe proposal device
5 Communication terminal
31 Input unit (one example of input means)
32 Feature vector generation unit
33 Selection unit (one example of selection means)
38 Transmission unit (one example of transmission means)
39 Reception unit (one example of receiving means)
3001 Recipe management DB
3002 Browsing history management DB (one example of browsing history management means)

1. A recipe proposal device for proposing a recipe to a consumer, the device comprising a processor configured to execute operations comprising:
receiving ingredients information as input, the ingredients information indicating available ingredients; and
selecting a specific recipe to be proposed to a predetermined consumer from predetermined recipes browsed by the predetermined consumer in the past on the basis of the recipe in which the ingredients indicated by the ingredients information are used.

2. The recipe proposal device according to claim 1, the processor further configured to execute operations comprising:
transmitting recipe information relating to the specific recipe to the communication terminal of the predetermined consumer.

3. The recipe proposal device according to claim 2, the processor further configured to execute operations comprising:
receiving, from the communication terminal, browsing information indicating a situation in which content of the recipe based on the recipe information has been browsed on the communication terminal of the predetermined consumer on the basis of the transmission of the recipe information; and
determining the browsing information as information identifying the predetermined recipe browsed by a predetermined consumer in the past.

4. The recipe proposal device according to claim 1, wherein the selecting further comprises selecting the specific recipe to be proposed to the predetermined consumer among the predetermined recipes browsed by a predetermined consumer in the past in accordance with the similarity with the recipe in which the ingredients indicated by the ingredients information are used.

5. The recipe proposal device according to claim 4, wherein the selecting further comprises selecting the specific recipe using the similarity obtained by a first feature amount calculated on the basis of information indicating the predetermined recipe browsed by a predetermined consumer in the past and a second feature value calculated based on the information indicating the recipe in which each ingredient indicated by the ingredient information is used.

6. The recipe proposal device according to claim 3, wherein
the determining the browsing information further comprises:
determining, as at least a part of the browsing information, consumer identification information, the consumer identification information identifying a predetermined consumer who has browsed in the past and recipe identification information, and the recipe identification information indicating the predetermined recipe associated with the consumer identification information, and
associating and determining a feature value calculated on the basis of information indicating the predetermined recipe browsed by a predetermined consumer in the past and recipe identification information indicating the predetermined recipe, and
the selecting further comprises selecting the specific recipe using the feature amount corresponding to the specific recipe information on the basis of the specific recipe information.

7. A recipe proposal method, for proposing a recipe to a consumer, comprising:
receiving ingredient information as input, the ingredient information indicating available ingredients;
selecting a specific recipe to be proposed to a predetermined consumer from predetermined recipes browsed by the predetermined consumer in the past on the basis of the recipe in which the ingredients indicated by the ingredients information are used.

8. A computer-readable non-transitory recording medium storing a computer-executable program instructions that when executed by a processor cause a computer system to execute operations comprising:
receiving ingredients information as input, the ingredients information indicating available ingredients; and
selecting a specific recipe to be proposed to a predetermined consumer from predetermined recipes browsed by the predetermined consumer in the past on the basis of the recipe in which the ingredients indicated by the ingredients information are used.

9. The recipe proposal device according to claim 2, wherein the selecting further comprises selecting the specific recipe to be proposed to the predetermined consumer among the predetermined recipes browsed by a predetermined consumer in the past in accordance with the similarity with the recipe in which the ingredients indicated by the ingredients information are used.

10. The recipe proposal method according to claim 7, further comprising:
transmitting recipe information relating to the specific recipe to the communication terminal of the predetermined consumer.

11. The recipe proposal method according to claim 10, further comprising:
receiving, from the communication terminal, browsing information indicating a situation in which content of the recipe based on the recipe information has been browsed on the communication terminal of the predetermined consumer on the basis of the transmission of the recipe information; and
determining the browsing information as information identifying the predetermined recipe browsed by a predetermined consumer in the past.

12. The recipe proposal method according to claim 7, wherein the selecting further comprises selecting the specific recipe to be proposed to the predetermined consumer among the predetermined recipes browsed by a predetermined consumer in the past in accordance with the similarity with the recipe in which the ingredients indicated by the ingredients information are used.

13. The recipe proposal method according to claim 12, wherein the selecting further comprises selecting the specific recipe using the similarity obtained by a first feature amount calculated on the basis of information indicating the predetermined recipe browsed by a predetermined consumer in the past and a second feature value calculated based on the information indicating the recipe in which each ingredient indicated by the ingredient information is used.

14. The recipe proposal method according to claim 11, wherein
the determining the browsing information further comprises:
determining, as at least a part of the browsing information, consumer identification information, the consumer identification information identifying a predetermined consumer who has browsed in the past and recipe identification information, and the recipe identification information indicating the predetermined recipe associated with the consumer identification information, and
associating and determining a feature value calculated on the basis of information indicating the predetermined recipe browsed by a predetermined consumer in the past and recipe identification information indicating the predetermined recipe, and
the selecting further comprises selecting the specific recipe using the feature amount corresponding to the specific recipe information on the basis of the specific recipe information.

15. The recipe proposal method according to claim 10, wherein the selecting further comprises selecting the specific recipe to be proposed to the predetermined consumer among the predetermined recipes browsed by a predetermined consumer in the past in accordance with the similarity with the recipe in which the ingredients indicated by the ingredients information are used.

16. The computer-readable non-transitory recording medium according to claim 8, the computer-executable program instructions when executed further causing the computer system to execute operations comprising:
transmitting recipe information relating to the specific recipe to the communication terminal of the predetermined consumer.

17. The computer-readable non-transitory recording medium according to claim 16, the computer-executable program instructions when executed further causing the computer system to execute operations comprising:
receiving, from the communication terminal, browsing information indicating a situation in which content of the recipe based on the recipe information has been browsed on the communication terminal of the predetermined consumer on the basis of the transmission of the recipe information; and
determining the browsing information as information identifying the predetermined recipe browsed by a predetermined consumer in the past.

18. The computer-readable non-transitory recording medium according to claim 8, wherein the selecting further comprises selecting the specific recipe to be proposed to the predetermined consumer among the predetermined recipes browsed by a predetermined consumer in the past in accordance with the similarity with the recipe in which the ingredients indicated by the ingredients information are used.

19. The computer-readable non-transitory recording medium according to claim 18, wherein the selecting further comprises selecting the specific recipe using the similarity obtained by a first feature amount calculated on the basis of information indicating the predetermined recipe browsed by a predetermined consumer in the past and a second feature value calculated based on the information indicating the recipe in which each ingredient indicated by the ingredient information is used.

20. The computer-readable non-transitory recording medium according to claim 17, wherein
the determining the browsing information further comprises:
determining, as at least a part of the browsing information, consumer identification information, the consumer identification information identifying a predetermined consumer who has browsed in the past and recipe identification information, and the recipe identification information indicating the predetermined recipe associated with the consumer identification information, and
associating and determining a feature value calculated on the basis of information indicating the predetermined recipe browsed by a predetermined consumer in the past and recipe identification information indicating the predetermined recipe, and
the selecting further comprises selecting the specific recipe using the feature amount corresponding to the specific recipe information on the basis of the specific recipe information.
